(19) United States
(12) Patent Application Publication
(10) Pub. No.: US 2026/0146479 A1
(43) Pub. Date: May 28, 2026

(54) LOCK FOR ELECTRONIC PRODUCT

(71) Applicant: JU-HAN YANG, Changhua County (TW)

(72) Inventor: JU-HAN YANG, Changhua County (TW)

(21) Appl. No.: 18/958,289

(22) Filed: Nov. 25, 2024

(51) Int. Cl. E05B 73/00

(52) U.S. Cl. CPC E05B 73/0082; E05B 73/0005

(57) ABSTRACT

A lock for an electronic product is provided, wherein the lock includes: a housing; a driving member movably assembled to the housing; a limiting unit including a limiting member swingably assembled to the housing, including a sleeving portion sleeving on the driving member and biased toward the blocking position so that the sleeving portion engages with the driving member; two engaging members movably assembled to the housing, each engaging member including an engaging portion, the driving member being configured to drive the engaging members away from each other; a lock assembled to the housing and including a locking member for driving the limiting member so that the sleeving portion does not engage with the driving member, the driving member can return in the first position, and the two engaging portions come closer to each other.

### BACKGROUND OF THE INVENTION

### Field of the Invention

The present invention relates to a lock, particularly to a lock for an electronic product.

### Description of the Prior Art

As technology advances and internet development brings convenience, portable electronic products, such as laptops and tablets, play an essential role in both daily life and work. These electronic products are lightweight and often costly, making them easy targets for theft or loss, where recovery becomes challenging. Typically, electronic products include an anti-theft hole, and by using an anti-theft lock, a locking member can be inserted and engaged within this hole, with the lock fixed to an immovable object, thus providing an anti-theft function. However, given that different electronic products vary in size and types, so do the anti-theft holes, necessitating a variety of lock sizes to fit. Thus, traditional anti-theft locks fail to meet various anti-theft hole sizes available on the market.

The present invention is, therefore, arisen to obviate or at least mitigate the above-mentioned disadvantages.

### SUMMARY OF THE INVENTION

The main object of the present invention is to provide a lock for an electronic product which is easy to operate and can be used with anti-theft holes of different sizes and types.

To achieve the above and other objects, a lock for an electronic product is provided, wherein the lock includes: a housing; a driving member movably assembled to the housing and movable between a first position and a second position; a limiting unit including a limiting member, the limiting member being assembled to the housing and swingable between an blocking position and a release position, including a sleeving portion sleeving on the driving member, the limiting member being normally biased toward the blocking position so that the sleeving portion engages with the driving member; two engaging members movably assembled to the housing and configured to be inserted in an anti-theft hole of the electronic product, an end of each of the two engaging members extending out from the housing including an engaging portion, wherein when the driving member moves from the first position to the second position, the driving member urges at least one of the two engaging members so that the two engaging portions move away from each other; a lock assembled to the housing and including a locking member, the lock being configured to selectively control movement of the locking member, wherein the locking member urges the limiting member to move toward the release position so that the sleeving portion does not engage with the driving member, the driving member can return in the first position, and the two engaging portions come closer to each other.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIGS. 2 and 3 are exploded views of an exemplary embodiment of the present invention;

FIGS. 4 to 7 are schematic views showing operation of an exemplary embodiment of the present invention; and

FIG. 8 is a cross-sectional view of another exemplary embodiment of the present invention.

### DETAILED DESCRIPTION OF THE PREFERRED EMBODIMENTS

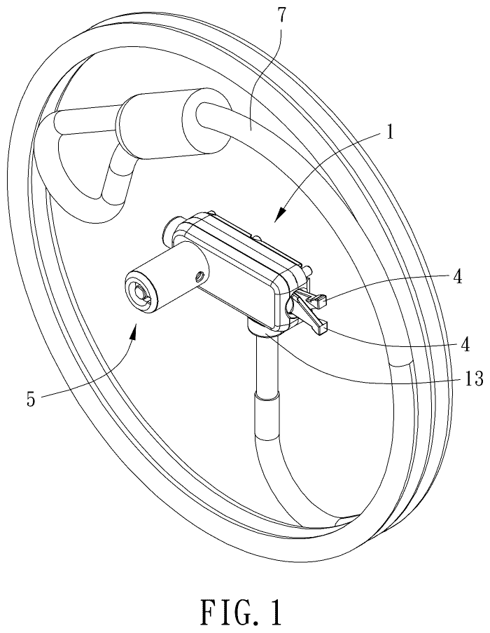

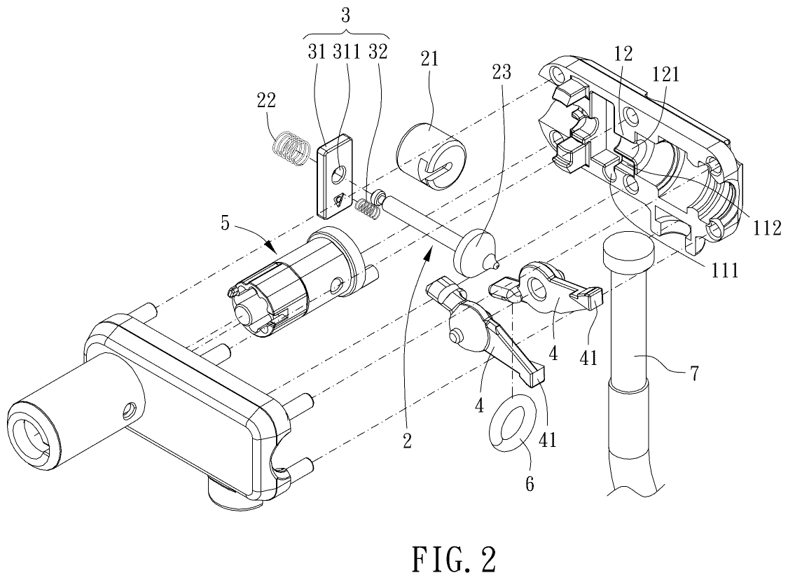

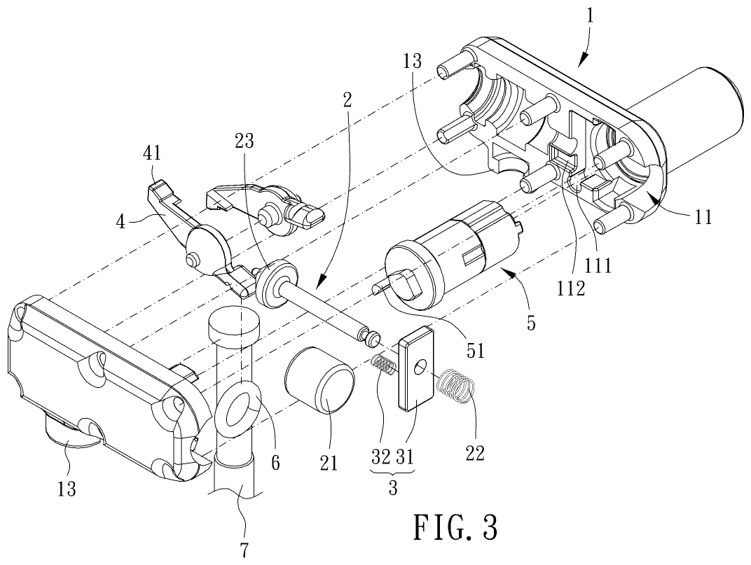

Please refer to FIGS. 1 to 7 for an exemplary embodiment of the present invention. A lock for electronic product of the present invention includes a housing 1, a driving member 2, a limiting unit 3, two engaging members 4, and a lock 5.

The driving member 2 is movably assembled to the housing 1 and is movable between a first position and a second position.

The limiting unit 3 includes a limiting member 31, the limiting member 31 is assembled to the housing 1 and swingable between a blocking position and a release position, the limiting member 31 includes a sleeving portion 311 sleeving on the driving member 2, and the limiting member 31 is normally biased toward the blocking position so that the sleeving portion 311 engages with the driving member 2.

The two engaging members 4 are movably assembled to the housing 1 and configured to be inserted in an anti-theft hole (not shown) of an electronic product. An end of each of the two engaging members 4 extending out from the housing 1 includes an engaging portion 41. When the driving member 2 moves from the first position to the second position, the driving member 2 urges at least one of the two engaging members 4 so that the two engaging portions 41 move away from each other.

The lock 5 is assembled to the housing 1 and includes a locking member 51. The lock 5 is configured to selectively control movement of the locking member 51, wherein the locking member 51 urges the limiting member 31 to move toward the release position so that the sleeving portion 311 does not engage with the driving member 2 and the driving member 2 can return to the first position, and the two engaging portions 41 come closer to each other. In this embodiment, the lock 5 can be controlled by a key (not shown) to drive the locking member 51.

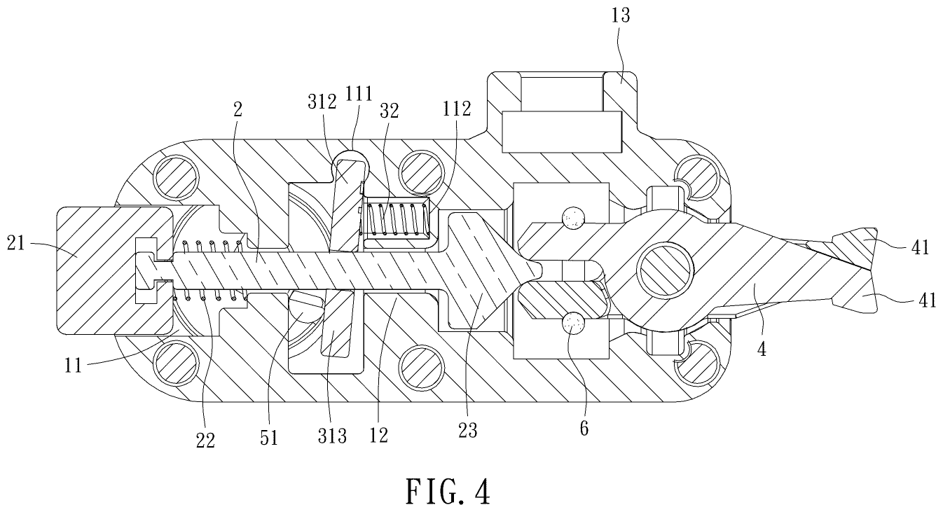

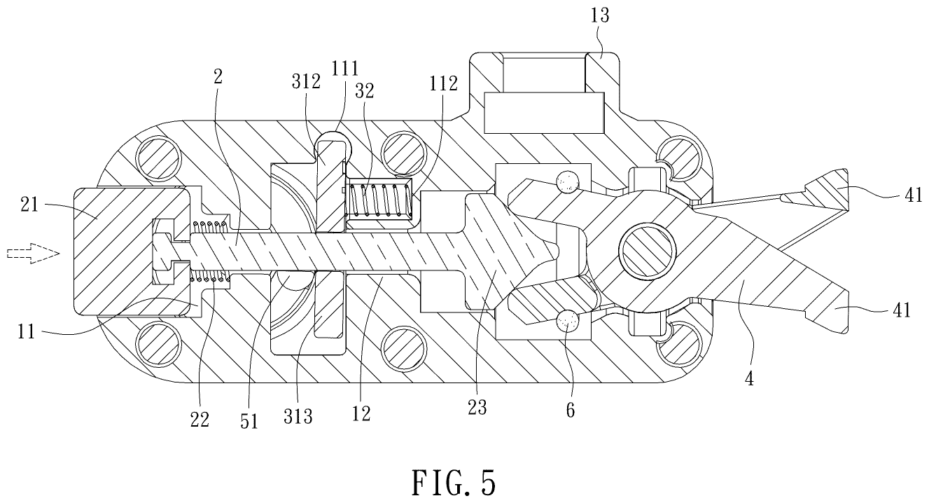

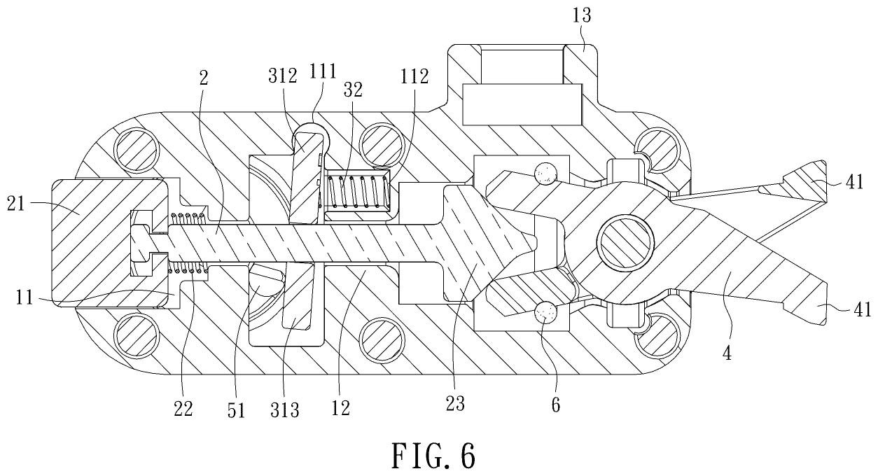

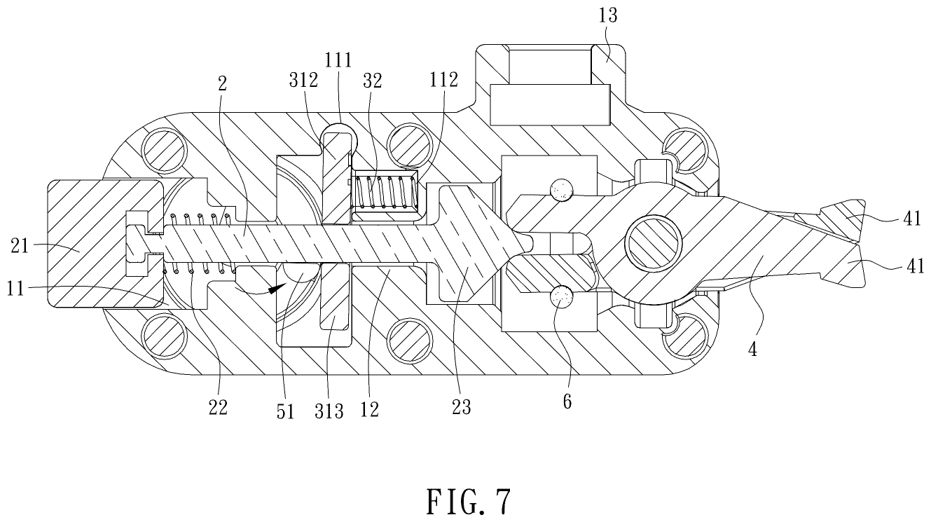

In an actual operation, in the initial state, the driving member 2 is located in the first position, and the two engaging portions 41 are close to each other (as shown in FIG. 4). When the two engaging members 4 are inserted in the anti-theft hole of the electronic product, the driving member 2 is controlled to move toward the second position, where it urges at least one of the engaging members 4 (in this embodiment, it urges both engaging members 4), causing the two engaging portions 41 to move away from each other such that the two engaging portions 41 can then engage the inner walls of the anti-theft hole (as shown in FIG. 5). Since the limiting member 31 is normally biased toward the blocking position, the sleeving portion 311 engages the driving member 2, preventing it from returning to the first position (as shown in FIG. 6). Consequently, the two engaging portions 41 cannot come closer, and the two engaging members 4 remain locked in the anti-theft hole, achieving the anti-theft functionality. To unlock, a key is used to control the locking member 51 to move, urging the limiting member 31 to move toward the release position (as shown in FIG. 7). This disengages the sleeving portion 311 from the driving member 2, allowing it to return to the first position, which enables the two engaging portions 41 to come closer to allow the two engaging members 4 to be removed from the anti-theft hole. Therefore, the present invention has a simple structure and is easy to operate, and the movement of the two engaging portions 41 away from each other makes it compatible with anti-theft holes of various sizes.

Specifically, the housing 1 includes a receiving room 11, and the locking member 51 and the limiting unit 3 are disposed within the receiving room 11. The receiving room 11 is in communication with the outside, and a press member 21 is disposed on an end of the driving member 2 remote from the two engaging members 4. When the driving member 2 is in the first position, the press member 21 is protrusive out from the receiving room 11, and when the driving member 2 is in the second position, the press member 21 is located within the receiving room 11. By pressing the press member 21, the driving member 2 can be moved toward the second position. Furthermore, when the limiting member 31 is in the blocking position and the press member 21 is located in the receiving room 11, and the driving member 2 cannot be freely moved to the first position. The present invention further includes a second elastic member 22 disposed between the housing 1 and the press member 21 to normally bias the driving member 2 toward the first position. When the limiting member 31 is in the release position, the second elastic member 22 urges the driving member 2 to return to the first position.

Specifically, the limiting member 31 includes a limiting end 312 and a free end 313. The limiting end 312 is constrained within the housing 1 and serves as a pivot portion so that the free end 313 is swingable between the blocking position and the release position. In this embodiment, a receiving groove 111 is disposed on one radial side of a bottom of the receiving room 11, and the limiting end 312 is inserted in the receiving groove 111 to form the pivot portion. An axial side of the bottom of the receiving room 11 includes a receiving hole 112, a first elastic member 32 is disposed within the receiving hole 112 to normally urge the free end 313 away from the two engaging members 4 (i.e., toward the blocking position). In this embodiment, the sleeving portion 311 is a hole, allowing the driving member 2 to slightly urge the limiting member 31 toward the release position when moving from the first position toward the second position without interference.

The housing 1 includes a blocking portion, and the blocking portion has a through hole 121 through which the driving member 2 is disposed. The driving member 2 includes an urging portion 23 on an end facing the two engaging members 4. The urging portion 23 has a diametric dimension larger than a diametric dimension of the through hole 121, and when the driving member 2 is in the first position, the blocking portion stops the urging portion 23.

Preferably, the urging portion 23 is a conical and tapers toward the two engaging members 4, which can effectively urge the two engaging members 4 to swing. In this embodiment, the two engaging members 4 are rotatably connected to the housing 1 in a crossed arrangement, and a third elastic member 6 is sleeved on the end facing the driving member 2 so that the two engaging portions 41 normally come closer to each other, thus automatically bringing the two engaging portions 41 together when the driving member 2 moves to the second position, making it more convenient for use.

The housing 1 further includes two flanges 13 extending outward and configured for a cable 7 being connected thereto. The cable 7 can be secured to an object (such as a table), thereby preventing the lock and the electronic product from being easily taken away.

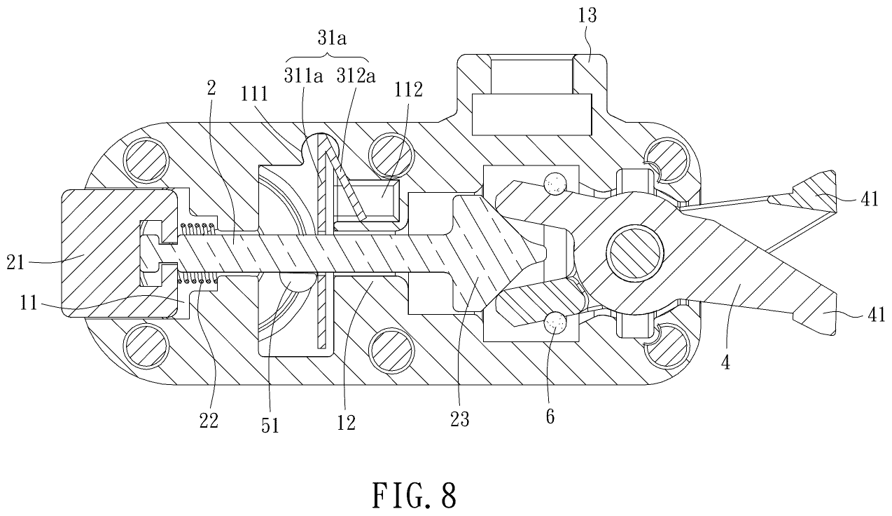

In other embodiments, as shown in FIG. 8, the limiting member 31a may include a plate portion 311a and a leg portion 312a. The plate portion 311a and the leg portion 312a are connected to each other at an acute included angle, the connection portion of the plate portion 311a and the leg portion 312a is inserted in the receiving groove 111. The leg portion is configured to resiliently abut a portion of the housing 1 adjacent to the receiving groove 111, allowing locking and unlocking the driving member 2.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A lock for an electronic product including:
a housing;
a driving member movably assembled to the housing and movable between a first position and a second position;
a limiting unit including a limiting member, the limiting member being assembled to the housing and swingable between an blocking position and a release position, including a sleeving portion sleeving on the driving member, the limiting member being normally biased toward the blocking position so that the sleeving portion engages with the driving member;
two engaging members movably assembled to the housing and configured to be inserted in an anti-theft hole of the electronic product, an end of each of the two engaging members extending out from the housing including an engaging portion, wherein when the driving member moves from the first position to the second position, the driving member urges at least one of the two engaging members so that the two engaging portions move away from each other;
a lock assembled to the housing and including a locking member, the lock being configured to selectively control movement of the locking member, wherein the locking member urges the limiting member to move toward the release position so that the sleeving portion does not engage with the driving member and the driving member can return in the first position, and the two engaging portions come closer to each other.

2. The lock claim 1, wherein the housing includes a receiving room, and the locking member and the limiting unit are disposed within the receiving room.

3. The lock claim 2, wherein the receiving room is in communication with an outside, an end of the driving member remote from the two engaging members includes a press member, when the driving member is in the first position, the press member is protrusive out from the receiving room, and when the driving member is in the second position, the press member is located within the receiving room.

4. The lock claim 3, further including a second elastic member, wherein the second elastic member is disposed between the housing and the press member to normally bias the driving member toward the first position.

5. The lock claim 2, wherein the limiting member further includes a limiting end and a free end, and the limiting end is constrained within the housing and serves as a pivot portion so that the free end is swingable between the blocking position and the release position.

6. The lock claim 5, wherein a receiving groove is disposed on a radial side of a bottom of the receiving room, and the limiting end is inserted in the receiving groove to form the pivot portion.

7. The lock claim 5, wherein an axial side of the bottom of the receiving room includes a receiving hole on, a first elastic member is disposed within the receiving hole to normally urge the free end away from the two engaging members, and the sleeving portion is a hole.

8. The lock claim 1, wherein the housing includes a blocking portion, the blocking portion includes a through hole, the driving member extends through the through hole, the driving member includes an urging portion on an end facing the two engaging members, the urging portion has a diametric dimension larger than a diametric dimension of the through hole, and when the driving member is in the first position, the blocking portion stops the urging portion.

9. The lock claim 8, wherein the urging portion is conical and tapers toward the two engaging members.

10. The lock claim 1, wherein the two engaging members are rotatably connected to the housing in a crossed arrangement, and a third elastic member is sleeved on an end of the two engaging members facing the driving member so that the two engaging portions normally come closer to each other.

11. The lock claim 4, wherein the limiting member further includes a limiting end and a free end, and the limiting end is constrained within the housing and serves as a pivot portion so that the free end is swingable between the blocking position and the release position; a receiving groove is disposed on a radial side of a bottom of the receiving room, and the limiting end is inserted in the receiving groove to form the pivot portion; the bottom of the receiving room includes a receiving hole on an axial side thereof, a first elastic member is disposed within the receiving hole to normally urge the free end away from the two engaging members, and the sleeving portion is a sleeved hole; the housing includes a blocking portion, the blocking portion includes a through hole, the driving member extends through the through hole, the driving member includes an urging portion on an end facing the two engaging members, the urging portion having a diametric dimension larger than a diametric dimension of the through hole, and when the driving member is in the first position, the blocking portion stops the urging portion; the urging portion is conical and tapers toward the two engaging members; the two engaging members are rotatably connected to the housing in a crossed arrangement, and a third elastic member is sleeved on an end of the two engaging members facing the driving member so that the two engaging portions normally come closer to each other; the housing further includes two flanges extending outward and configured for a cable being connected thereto; the lock is configured to be controlled by a key to drive the locking member.
